(19) United States
(12) Patent Application Publication
(10) Pub. No.: US 2002/0112538 A1
(43) Pub. Date: Aug. 22, 2002

(54) Micromechanical component

(76) Inventors: Stefan Pinter, Reutlingen (DE); Frank Fischer, Gomaringen (DE); Arnold Rump, Munchen (DE)

Correspondence Address: KENYON & KENYON, ONE BROADWAY, NEW YORK, NY, 10004, US

(21) Appl. No.: 10/045,691

(22) Filed: Oct. 19, 2001

(30) Foreign Application Priority Data
Oct. 20, 2000 (DE) 100 51 973.3

(51) Int. Cl. G01P 15/14

(52) U.S. Cl. 73/514.32; 73/504.12; 73/504.02

(57) ABSTRACT

A micromechanical component is described, in particular an acceleration sensor or a rotational speed sensor having a seismic mass device which is flexibly mounted using at least one double U spring and can be deflected in at least one direction by an external acceleration. At least one nap stop is provided to limit the deflection of the double U spring.

### FIELD OF THE INVENTION

The present invention relates to a micromechanical component, in particular an acceleration sensor or a rotational speed sensor having a seismic mass device which is flexibly mounted using at least one double U spring and can be deflected in at least one direction by an external acceleration.

Although it can be applied to any micromechanical components and structures, in particular sensors and actuators, the present invention and the underlying problem are elucidated with reference to a micromechanical acceleration sensor that can be manufactured using silicon surface micromachining technology.

### BACKGROUND INFORMATION

Acceleration sensors, in particular micromechanical acceleration sensors manufactured using surface or volume micromachining technology, have an increasing market share in the automotive equipment industry and are increasingly replacing the piezoelectric acceleration sensors customarily used to date.

The known micromechanical acceleration sensors normally operate so that the flexibly mounted seismic mass device, which can be deflected in at least one direction by an external acceleration, on deflection causes a change in the capacitance of a differential capacitor device which is connected to it and has a comb structure; this change in capacitance is a measure of the acceleration.

At the time of the deflection, the combs of the differential capacitor device may occasionally contact one another and remain stuck together. It must also be ensured that the movable component parts do not contact one another, since the smallest adhesion or attraction forces of less than 5 μN are sufficient to result in permanent deflection.

This phenomenon of solid adhesion in micromechanical components is generally referred to in the literature as “stiction.” “Stiction” is the tendency of two solid surfaces in mechanical contact with one another to stick together. An overview of the current state of discussions is given in R. Maboudian, R. T. Howe; Critical Review: Adhesion in surface micromechanical structures; J. Vac. Sci. Technol. B 15(1), Jan./Feb. 1997, 1, as well as in K. Komvopoulos; Surface Engineering and Microtribology for Microelectromechanical Systems; Wear 200(1996), 305-327.

Stiction basically means a surface effect resulting from the buildup of van der Waals and capillary forces, as well as from electrostatic interaction, and the formation of solid and hydrogen bridges.

The underlying known process sequence of surface micromachining technology for the manufacture of acceleration sensors and rotational speed sensors is described, for example, by Offenberg et al. in Acceleration Sensor in Surface Micromachining for Airbag Applications with High Signal/Noise Ratio; Sensors and Actuators, 1996, 35. The material used in which the mechanically movable elements are structured is highly phosphorus-doped polycrystalline silicon.

In such acceleration sensors and rotational speed sensors for the low g-range, which are manufactured using surface micromachining technology (SMM technology), the mechanically functional components are formed in approximately 10 μm thick polysilicon. In particular for low-g sensors, a slight overload may result in deflection of the seismic mass in the mechanical limit stops and adhesion of the sensor, since the restoring forces of the springs are small. In this state the mass is permanently deflected and the sensor is no longar operational. This phenomenon is referred to as “in-use sticking.”

The previously proposed remedy measures were based only on the shape and function of the contact points of the mechanical stops within the seismic mass.

FIG. 2 schematically shows the mechanically functional plane of a known acceleration sensor to illustrate the critical points in the design, where in-use sticking may occur in principle.

FIG. 2 shows seismic mass 1, fixed electrodes 1a, movable electrodes 1b on seismic mass 1, fixed stop base 2, stop nap 3, double U springs 4 for elastic mounting of seismic mass 1, edges 5 made of epitaxial polysilicon, connecting webs 6 between double U springs 4 and fixed anchors 7.

In the acceleration sensor shown in FIG. 2, in the event of an overload, areas of the movable mass and of the fixed polysilicon sensor structures may come into contact at some points. In FIG. 2 the possible contact points A-E are marked with a circle.

Contact point A: Contact between seismic mass 1 and fixed stop base 2 will always occur on stop nap 3 in the event of an overload.

Contact point B: In the event of a significant overload, fixed electrodes 1 a and movable electrodes 1b of seismic mass 1 may come into contact. At these points permanent retaining forces may arise. In general, these bar structures are selected to be sufficiently rigid so that contact only occurs at very high accelerations. Rigidity is a problem when potential differences occur between the electrodes, e.g., in wire bonding during the assembly of the sensor module.

Contact point C: Vibrations may be induced in the arms of double U spring 4, which may permanently stick together.

Contact point D: The arms of double U spring 4 may hit epipoly edge 5 and adhere thereto.

Contact point E: The area of connecting webs 6 between U springs 4 may deflect in the event of an overload and snap against fixed anchor 7.

### SUMMARY OF THE INVENTION

The micromechanical component according to the present invention has the advantage that stiction can be largely prevented.

The measures according to the present invention relate in particular to acceleration sensors having double U springs. The proposed design measures in the polysilicon layer should prevent large surfaces of the sensor structure, opposite one another, from coming excessively close to one another in the event of an overload, giving rise to electrostatic interactions. According to this principle, preferably all distances between large surfaces opposite one another are increased as long as this does not affect the function of the sensor (for example, the distance at rest between the electrode fingers is not modified).

Spacers in the form of naps are introduced at the points where critical deflection of sensor structures at the double U springs may occur in the event of an overload, so that when the deflected structure is stopped, only small surfaces come into contact or close to one another.

The measures according to the present invention only affect the sensor design, and require no change in the process. Also the measure in no way affects the functionality of the sensor. The improvement only becomes effective in the event of an overload, when uncontrolled deflection (vibration) of the unsupported SMM structures and mechanical contacts in the sensor structure occur due to external accelerations, for example, in the event of a drop test.

The present invention provides design measures for the mechanically functional sequence of layers capable of considerably reducing in-use sticking. This reduces the risk of in-factory failure and field failure.

According to a preferred refinement, a plurality of nap stops are provided to limit the deflection of the double U spring.

According to another preferred refinement, at least one nap stop is provided between the arms of the double U spring. This stop is preferably located in the center. It prevents the two halves of the U from sticking together.

According to another preferred refinement, the double U spring is surrounded by an edge, with at least one nap stop being provided on the edge. This prevents adhesion to the edge.

According to another preferred refinement, two double U springs are connected in series, with at least one nap stop being provided between them outside one of the two double U springs. This prevents the two springs from sticking together.

According to another preferred refinement, at least two nap stops are provided outside the double U springs and are arranged symmetrically.

According to another preferred refinement, the distance between the bars of the double U springs and between the bars of the double U springs and the edge is at least 4 μm.

### BRIEF DESCRIPTION OF THE DRAWINGS

FIG. 1 schematically shows the mechanically functional plane of an acceleration sensor according to one embodiment of the present invention.

FIG. 2 schematically shows the mechanically functional plane of a known acceleration sensor to illustrate the critical points in the design, where in-use sticking may occur in principle.

### DETAILED DESCRIPTION

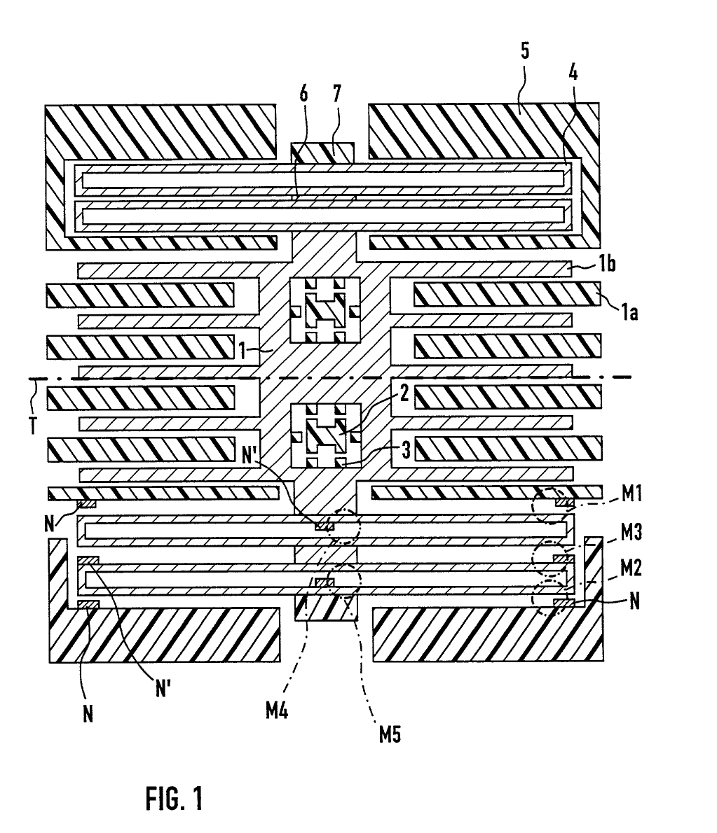

FIG. 1 schematically shows the mechanically functional plane of an acceleration sensor according to one embodiment of the present invention.

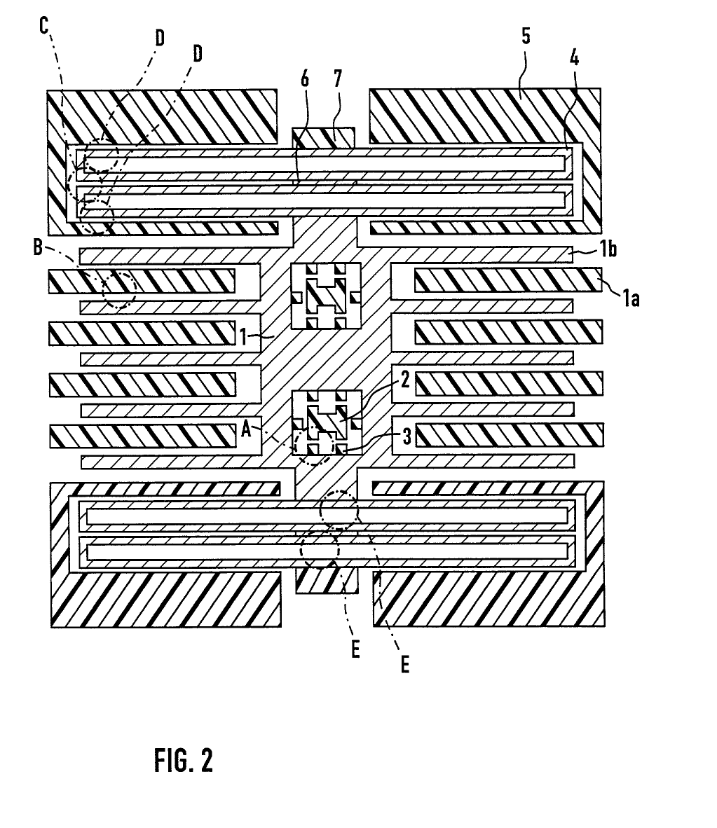

In FIG. 1 the same reference symbols as used in FIG. 2 denote the same or functionally equivalent components.

More recent experiments confirmed the assumption that the permanent deflection is not maintained by retaining forces on the stop surfaces. It has been shown that, after a mechanical overload, contact occurs between components of the seismic mass and fixed sensor structures even at other points of the sensor design. Contact preferably occurs between the arms of the double U spring and the surrounding polysilicon.

In order to reduce in-use sticking, in the embodiment illustrated in FIG. 1, the potential contact points A, C, D, and E are arranged in the component so that either only small surfaces contact one another or the restoring force of the deflected sensor structure is sufficiently large to overcome the retaining forces.

For comparison with the related art according to FIG. 2, FIG. 1 shows a separating line T, the design changes only being shown in the bottom part of FIG. 1.

The following improvements were made to the known structure according to FIG. 2:

Improvement M1: The distance between double U springs 4 and epipoly frame 5 was increased. This increases the restoring force of double U springs 4 upon mechanical stop against epipoly frame 5. It is recommended that the distance be increased from approx. 2 μm to at least 4 μm.

Improvement M2: One or more spacers in the form of small naps N have been provided on the side of epipoly frame 5 facing double U spring 4 or on the side of double U spring 4 facing spring frame 5 at the location of greatest deflection (edge area). Thus the contact area between these components is reduced and the remaining surfaces are kept farther apart. Naps N should be between 2 μm and 20 μm wide and at least 0.5 μm long.

Improvement M3: The distance between the U springs (length of connecting piece 6) has been increased from approx. 2 μm to over 4 μm.

Improvement M4: The opening of double U spring 4 (distance between the bars of a U spring) was increased from approx. 2 μm to over 4 μm.

Improvement M5: Nap stops N′ were introduced between the arms of double U springs 4. These nap stops N′ are located in the central area (middle) of the greatest deflection of the respective double U spring 4 and also in the edge area (outside) of the greatest deflection between two double U springs.

Tests have shown that the improvements introduced M1-M4 result in a substantial reduction of in-use sticking in the overload range.

Although the present invention was described above with reference to preferred embodiments, it is not limited thereto, but can be modified in a plurality of ways.

Of course, the present invention is not only applicable to an acceleration sensor or rotational speed sensor, but to any micromechanical component having double U springs.

What is claimed is:

1. A micromechanical component, comprising:
at least one double U spring;
a seismic mass device that is flexibly mounted using the at least one double U spring and is capable of being deflected in at least one direction by an external acceleration; and
at least one nap stop for limiting a deflection of the at least one double U spring.

2. The micromechanical component according to claim 1, wherein:
the micromechanical component corresponds to one of an acceleration sensor and a rotational speed sensor.

3. The micromechanical component according to claim 1, wherein:
the at least one nap stop includes a plurality of nap stops.

4. The micromechanical component according to claim 1, wherein:
the at least one nap stop is disposed between arms of the at least one double U spring.

5. The micromechanical component according to claim 1, further comprising:
an edge, wherein:
the at least one double U spring is surrounded by the edge, and
the at least one nap stop is disposed on the edge.

6. The micromechanical component according to claim 1, wherein:
the at least one double U spring includes two double U springs that are connected in series, and
the at least one nap stop is disposed between the two double U springs outside one of the two double U springs.

7. The micromechanical component according to claim 1, wherein:
the at least one nap stop includes at least two nap stops that are disposed outside the at least one double U spring and are symmetrically arranged.

8. The micromechanical component according to claim 1, further comprising:
an edge, wherein:
a distance between bars of the at least one double U spring is at least 4 μm, and
a distance between the bars of the at least one double U spring and the edge is at least 4 μm.
